(19) United States
(12) Patent Application Publication
(10) Pub. No.: US 2023/0194335 A1
(43) Pub. Date: Jun. 22, 2023

(54) A MULTI-SENSOR BASED MECHANICAL MEASUREMENT SYSTEM AND ITS MEASUREMENT METHOD

(71) Applicant: Yang BAI, Shanghai (CN)

(72) Inventor: Yang BAI, Shanghai (CN)

(21) Appl. No.: 17/926,767

(22) PCT Filed: Jul. 29, 2020
(86) PCT No.: PCT/CN2020/105449

§ 371 Date: Nov. 21, 2022

(30) Foreign Application Priority Data
Aug. 3, 2019 (CN) 201910714400.1

(51) Int. Cl. G01G 23/01; G01L 25/00; G01L 5/16; G01G 19/393

(52) U.S. Cl. CPC G01G 23/01; G01L 25/00; G01L 5/16; G01G 19/393

(57) ABSTRACT

The invention discloses a multi-sensor-based mechanical measurement system, comprising a sensor, a digital-to-analog conversion unit and a calculation unit; The said sensor include a plurality of sensors, and each of the sensors is connected to the said digital-to-analog conversion unit through a respective analog input channel; The said digital-to-analog conversion unit converts the data and transmits it to the calculation unit; The said computing unit performs a primary calibration on the said sensor corresponding to each of the said analog input channels according to the signal transmitted by each of the analog input channels one by one respectively, and performs secondary calibration according to the primary calibration results of all the said sensors. The invention has the advantages of high precision, high stability, high reliability, low error, low cost, easy maintenance, low failure rate, no need for pairing, strong adaptability to environment and location, light and compact, flexible expansion and the like.

### FIELD

The invention relates to the field of mechanical measurement, in particular to a multi-sensor-based mechanical measurement system and a measurement method thereof.

### BACKGROUND

Today's multi-sensor mechanical measurement systems generally have problems such as poor consistency, difficult adjustment and trimming, cumbersome structure, poor environmental adaptability, low measurement accuracy, and limited number of sensors that can be integrated in the same system.

Taking the most common pressure (weighing) system as an example, according to the different factors such as its range and tray (pallet/pad) area, the common pressure (weighing) system has 4 sensors (mostly arranged in the four corners of the “ [symbol] ” shape), 6 sensors (there are several arranges such as 6 cross points at “ [symbol] ” shape) and 8 sensors (mostly 8 cross points at “ [symbol] ” shape).

The characteristics of its implementation are:

1. Multiple sensors in the same system (such as the same weighbridge) first pass through the junction box (also called: “hub”, “concentrator”, “accumulator”, etc.) equipment, and accumulate its output voltage or current in series or parallel. Then, the accumulated analog quantity is output to the analog quantity input (Al) channel of the instrumentation equipment for digital-to-analog conversion (ADC) and calibration.

2. Multiple sensors in the same system (eg the same weighbridge) are rigidly (screwed, welded, glued, etc.) fixed to the same chassis, frame, connector and/or tray.

FIG. 1 shows a typical connection of an existing multi-sensor mechanical measurement system. Among them, a plurality of sensors 2 are connected to a junction box 6. After the junction box 6 accumulates the analog signals input by each sensor, it is transmitted to the ADC device 8 through an AI channel 7 to be converted into digital signals.

FIG. 2 takes the weighing (pressure) system (side view) applying the existing multi-sensor mechanical measurement system as an example. Among them, a plurality of sensors 2 are fastened to the same measuring surface (weighing tray, etc., also known as measuring side, or measuring end) 5 and supporting surface (chassis, frame, etc., also known as support side, or support end) 3 in a rigid (usually bolted) manner.

FIG. 3 takes a tensile force system (side view) using an existing multi-sensor mechanical measurement system as an example. Among them, a plurality of sensors 2 are fastened on the same measuring surface 5 (usually consists of steel cables and connecting plates/connecting panels, etc., also known as the measurement side) and supporting surface 3 (usually also consists of steel cables and connection plates, also known as the support side) in a rigid (usually bolted) manner.

As can be seen from the tension system described in the above example, its support side and measurement side can be completely equivalent and interchangeable. For example, if the measuring surface 5 in the above example is regarded as a supporting surface, then the supporting surface 3 can also be regarded as a measuring surface.

The main problem of the above structure is: the consistency between the sensors and the stress generated by the rigid connection has become important reasons that seriously affect the measurement accuracy of the weighing instrument.

It is well known in the industry that due to the production process and other reasons, it is difficult to ensure similar consistency even between different mechanical sensors of the same batch, same model, and same range.

For example, taking the above pressure/weighing system as an example, even if two 8 kg range pressure/load cells A and B of the same batch and model, their voltage-weight (or current-weight) calibration curves may be completely different. For example, in an environment of 1 standard atmosphere, 25° C., and an excitation voltage of 3.3V, the output voltage of sensor A may be 3.2 mV after a 3 kg load is loaded, while the output voltage of sensor B may be 2.6 mV under the same situation. The final “voltage-weight” calibration curves of the above two sensors may be shown in FIG. 4, respectively. In the coordinate system of FIG. 4, the X-axis represents the voltage, and the Y-axis represents the weight. The solid line is the “voltage-weight” calibration curve of sensor A in the above example, and the dotted line is the “voltage-weight” calibration curve of sensor B. It can be clearly drawn from FIG. 4 that simply accumulating the output voltages (or currents) of different sensors with inconsistent calibration curves and then using them as the input value of the AI channel of the instrumentation will have a great impact on the accuracy.

For the above example, when the input voltage of the AI channel is 5.8 mV, the instrument cannot know whether the final value of 5.8 mV at this time is obtained from the A sensor output of 3.2 mV+the B sensor output of 2.6 mV, or the B sensor output of 3.2 mV and the A sensor output of 2.6 mV, or other combinations such as A sensor output 3.0 mV and B sensor output 2.8 mV.

As can be seen from FIG. 4, in the two most extreme cases of the above example, if all the 5.8 mV readings input to the AI channel come from sensor A, the real weight Ya2 of the current load should be 6.2 kg; On the contrary, if the current reading of 5.8 mV input to the AI channel is all from sensor B, the real weight Yb2 of the current load should be 5.6 kg. Therefore, when we only know that the output superposition value of sensor A and sensor B is 5.8 mV, we can only roughly know that the real load is between 5.6 kg and 6.2 kg, which obviously greatly reduces the overall accuracy of the weighing system.

This problem is known as “eccentric load error”, which is when the same object is placed in different positions on the scale, or the same force is applied to the scale at different angles and/or positions, and its reading changes.

At present, the main method to solve this kind of eccentric load error problem is to add 1 or 2 adjustable resistors (potentiometers) for each sensor in the junction box, and adjust the excitation (input) voltage and/or output voltage for each sensor individually. However, this method still has the following disadvantages:

The essence of this type of adjustment is to approximately add a fixed constant value to the input voltage and/or output voltage (or current) of the sensor (of course, the constant can be negative); in other words, this method is to add or subtract a constant on the X-axis and Y-axis of the calibration curve shown in FIG. 3, respectively.

Obviously, this approach can only improve its consistency to a limited extent, and cannot really tune multiple sensors to be consistent. FIG. 5 shows an optimal adjustment result for the situation described in the above example through the junction box. It can be seen that it calibrates the deviations of the two sensors under zero point and low load conditions, but their deviations under high load conditions are amplified instead.

Taking a step back, even if we idealize a complex, nonlinear calibration curve into a simple, linear straight line, just adding or subtracting a constant in the direction of the X-axis and the Y-axis obviously also cannot fit the problem that their slopes are different.

On the whole, the above-mentioned multi-way junction box that accumulates the output voltage or current of the sensors in series or parallel has the following problems:

1. Poor accuracy: The problem of eccentric load error caused by inconsistent sensor calibration curves cannot be overcome, resulting in poor measurement accuracy.

2. Difficulty in pairing: Due to the above problems, the shapes of the calibration curves of multiple sensors working in the same measurement system are required to be as consistent as possible (or when idealizing the curve as a straight line, their slopes should be as consistent as possible). However, in the existing production process, it is difficult to achieve such consistency even among different sensors of the same batch and model. This results in:
a) Pairing is expensive: It often takes a lot of work to find two sensors that work together in general. It is even more difficult to pair 4, 8, 16 or more sensors with each other.
b) Difficulty repairing: Once one sensor in a set is damaged, it is more difficult (and often nearly impossible) to find a replacement to mate with other existing undamaged sensors. Therefore, in most cases, if one sensor is damaged, the entire measuring system is scrapped.

3. Complex tuning: The consistency adjustment between multiple sensors is complex, and it is often necessary to repeatedly adjust each sensor. The adjustment of the potentiometer often affects each other. For example, after adjusting the sensors A and B, then adjusting the sensors A and C, which may in turn destroy the consistency between the sensors A and B that have been previously adjusted. Therefore, adjusting the junction box potentiometer is a painful process full of trial and error. And as the number of sensors increases, the complexity of the process will skyrocket exponentially.

To make matters worse, mechanical sensors are generally sensitive to external factors such as temperature, humidity, and air pressure. These external factors further increase the complexity of tuning, and at the same time reduce the overall adaptability of the system to the above-mentioned external environmental factors.

4. Additional noise: As an analog signal superposition and amplification device, the junction box will undoubtedly add additional noise to the signal finally sent to the AI channel, thereby affecting the measurement accuracy.

The influence of external environment such as electromagnetic interference, temperature and humidity further increases the unpredictability of its noise, which has a negative impact on the overall working stability of the system.

For example, the stability of electronic devices such as potentiometers, transistors, resistors, capacitors, inductors, ICs, etc., as well as their disturbances caused by the above environmental influences, will cause interference to the final output signal.

5. Additional failures: The junction box acts as an additional intermediate device between the sensor and the analog-to-digital converter (ADC), introducing additional failure points to the overall system.

6. Limited number of sensors: The more sensors that work together in the same system, the more (in geometric progression) difficult it will be for pairing and tuning, and the worse the overall measurement accuracy will be. Therefore, the number of sensors in the same measurement system is usually limited to 8 or less. This actually limits its application range in many occasions, and it is impossible to configure a suitable number of sensor matrices according to actual needs (range, area, accuracy, etc.) to meet its requirements for range, area, accuracy, etc.

Rigid connections between multiple sensors via the same chassis and/or frame and/or tray also pose a number of problems:

1. Rigidly connected multiple sensors need to be strictly trimmed, otherwise problems such as eccentric error (also known as corner load error) will occur during measurement, resulting in inaccurate measurement results and making trim work time-consuming and cumbersome.

2. Even after strict trimming, each time the location is moved will usually cause errors to occur again, requiring re-trimming, which requires a lot of work.

3. Since it is impossible for components such as trays, frames, and chassis to achieve absolute rigidity and it is difficult to ensure absolute levels, there will be lever (seesaw) or mutual torsion stress between the sensors, resulting in a decrease in the accuracy of the measurement results.

4. In order to be as close to a rigid body as possible, the pallets (tray/pad), frames, chassis and other components are made of materials such as thick steel or alloys that are as strong as possible. It is not only material wasted, but it also results in equipment that is bulky, difficult to handle and maintain.

To sum up, the existing multi-sensor mechanical measurement systems mainly have problems such as low accuracy, high cost, heavy workload, sensitivity to the environment and location, and difficult maintenance.

On the other hand, the single-sensor measurement system has the disadvantages of limited range, poor adaptability to practical application scenarios, and small measurement area (for example: the maximum pallet area that can be measured by a single weighing/pressure sensor is usually less than 50 cm×50 cm, and if it is larger, it is easy to cause problems such as excessive eccentric error due to the excessively long force arm.).

### SUMMARY

The purpose of the present invention is to provide a multi-sensor mechanical measurement system with high precision, high stability, high reliability, low error, low cost, easy maintenance, low failure rate, strong adaptability to environment and location, flexible expansion and light structure.

In order to achieve the above object, the technical scheme of the present invention is:

A multi-sensor-based mechanical measurement system, comprising a sensor, a digital-to-analog conversion unit and a calculation unit; the said sensor include a plurality of sensors, and each of the sensors is connected to the said digital-to-analog conversion unit through a respective analog input channel; the said digital-to-analog conversion unit converts the data and transmits it to the calculation unit; the said computing unit performs a primary calibration on the said sensor corresponding to each of the said analog input channels according to the signal transmitted by each of the analog input channels one by one respectively, and performs secondary calibration according to the primary calibration results of all the said sensors. The computing unit described in the present invention can be a single or any number of digital computing devices with computing capabilities, including but not limited to: computers, single-board computers, embedded industrial control equipment, FPGA, ASIC, DSP equipment, etc.

A multi-sensor-based mechanical measurement system, further comprising a support side, One ends of the plurality of said sensors are all connected to the said support side, the other ends of the plurality of said sensors are respectively connected to the plurality of measurement sides, and each of the said measurement sides is not connected to each other.

Where “support side” can be anything that supports and/or secures the sensor, such as (including but not limited to): plane/curved surface (support surface/support plate/support pier), end point (support end), cable (support wire/bearing cable), rod (support rod), hook (load-bearing hooks), frames, and trays. And “measurement side” can be anything that can help the sensor dock and/or carry its test load, such as (including but not limited to): plane/curved surface (measurement surface/measurement plate), end point (measurement end), cable (measurement wire/load-bearing cable), rod (measurement rod), hook (load-bearing hook), frames, and trays.

Further, a plurality of the measurement sides are connected through a connection layer.

Further, a buffer layer is provided between the connection layer and the measurement side.

A measurement method based on a multi-sensor mechanical measurement system, comprising the following steps:

Step 1: Send the signals of multiple sensors to the digital-to-analog conversion unit through their respective analog input channels;

Step 2: Perform a calibration on each of the sensors respectively;

Step 3: Perform secondary calibration according to the primary calibration results of all the sensors.

Further, the secondary calibration in the said step 3 includes the following steps:

Step 3.1: Perform conversion processing of arbitrary complexity on the output measurement value of each sensor after primary calibration, and use the processing result as the output value;

Step 3.2: Accumulate the output value in the step 3.1, and output the accumulated value;

Step 3.3: Perform further processing such as taring, calibration, and arbitrary complexity transformation on the accumulated value in step 3.2, and use the processing result as the final result of the secondary calibration.

Advantages of the invention over the prior art:

Since the invention does not need to use a junction box or similar equipment, the problems of high adjustment cost, poor precision, difficult pairing, extra noise, extra fault points, and an upper limit of the number of sensors caused by the junction box are completely eliminated.

In the present invention, since each sensor has its own dedicated AI channel, the system can accurately calibrate each sensor separately, so that each sensor can maintain its dedicated precise calibration curve separately; it effectively prevents the inaccuracy and configuration difficulties caused by the superposition of different calibration curves. In addition, problems such as difficulty in sensor pairing in the process of equipment production and maintenance are also avoided. At the same time, it also ensures that the system can perform real-time tracking and calibration of deviations caused by various internal and external factors such as temperature, humidity, air pressure, creep, condensation, dust, and fatigue for each sensor respectively. It ensures that each sensor is not only calibrated accurately during initialization, but also maintains its long-term stable and accurate work during subsequent use.

In the present invention, because the sensors are not related to each other (not connected), they form independent measurement units respectively, and independently complete the measurement (ADC and calibration) of their own components; it makes its range, area and other factors become system characteristics that can be linearly expanded, which significantly saves materials, reduces production costs, reduces product size, and makes products more portable and easy to deploy.

Since the optional connection layer of the present invention is a flexible element, although theoretically, stress (mainly mutual torsion force) can be generated between different sensors after the connection layer is implemented, but because the stress is too weak, it can usually be ignored.

### BRIEF DESCRIPTION OF DRAWINGS

FIG. 1 is a schematic structural diagram of an existing multi-sensor mechanical measurement system.

FIG. 2 is a schematic structural diagram of a pressure/weighing system applying an existing multi-sensor mechanical measurement system.

FIG. 3 is a schematic structural diagram of a tensile force system applying an existing multi-sensor mechanical measurement system.

FIG. 4 is a “voltage-weight” calibration curve of two sensors in an existing multi-sensor mechanical measurement system.

FIG. 5 is the optimized calibration curve of “voltage-weight” of two sensors in the existing multi-sensor mechanical measurement system.

FIG. 6 is a schematic structural diagram of the multi-sensor-based mechanical measurement system of the present invention.

FIG. 7 is a top view of a pressure/weighing system to which the present invention is applied.

FIG. 8 is a side view of FIG. 7.

FIG. 9 is a schematic structural diagram of a tension system applying the present invention.

FIG. 10 is a schematic structural diagram of another embodiment of the tension system to which the present invention is applied.

FIG. 11 is a schematic structural diagram of another embodiment of the pressure/weighing system to which the present invention is applied.

FIG. 12 is a schematic structural diagram of another embodiment of the pressure/weighing system to which the present invention is applied.

FIG. 13 is a schematic structural diagram of another embodiment of the tension system to which the present invention is applied.

FIG. 14 is a schematic structural diagram of still another embodiment of the tension system to which the present invention is applied.

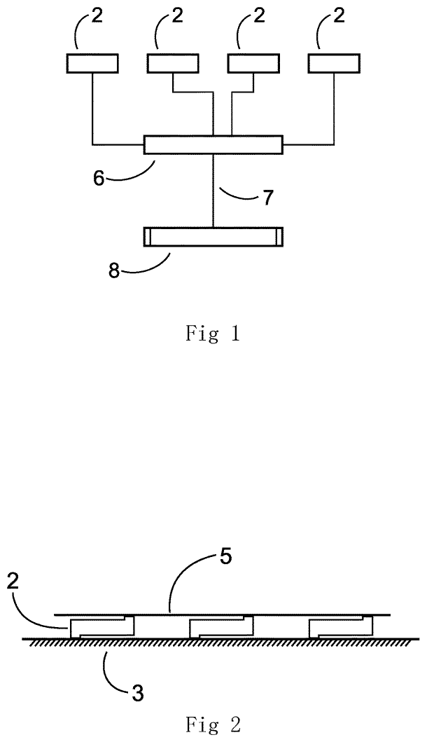

### DETAILED DESCRIPTION OF PRESENT INVENTION

Embodiments of the present invention are further described below with reference to the accompanying drawings.

Please refer to FIG. 6, a multi-sensor-based mechanical measurement system includes a sensor 2, a digital-to-analog conversion unit 8 and a calculation unit; the said sensor 2 include a plurality of sensors, and each of the said sensors 2 is connected to the said digital-to-analog conversion unit 8 through a respective analog input channel 7; the said digital-to-analog conversion unit 8 converts the data and transmits it to the said calculation unit; the said computing unit performs a primary calibration on the said sensor 2 corresponding to each of the said analog input channels 7 according to the signal transmitted by each of the analog input channels 7 one by one respectively, and performs secondary calibration according to the primary calibration results of all the said sensors 2. The computing unit described in the present invention can be a single or any number of digital computing devices with computing capabilities, including but not limited to: computers, single-board computers, embedded industrial control equipment, FPGA, ASIC, DSP equipment, etc.

Primary calibration means that each sensor 2 has its own dedicated AI channel 7, so that the system can perform accurate calibration for each sensor 2 separately, so as to maintain its precise calibration curve for each sensor 2 respectively. This effectively prevents the inaccuracy and configuration difficulties caused by the superposition (accumulation) of different calibration curves. In addition, problems such as difficulty in sensor pairing in the process of equipment production and maintenance are also avoided.

Not only that, but assigning one or more AI channels to each sensor 2 (which can be used for other supporting environmental sensors) also ensures that the system can perform the real-time tracking and calibration of deviations caused by various internal and external factors such as temperature, humidity, air pressure, creep, condensation, dust, and fatigue for each sensor respectively. It ensures that each sensor is not only calibrated accurately during initialization, but also maintains its long-term stable and accurate work during subsequent use.

The process of secondary calibration can range from simple arithmetic accumulation to arbitrarily complex expressions, or arbitrarily complex arithmetic and logical operation codes.

It should be noted that, unless otherwise specified, the “calibration curve” in this article is a general term. In actual calibration, various methods such as straight lines, piecewise functions, and curves (including but not limited to algorithms such as Lagrangian interpolation, Newton interpolation, etc.) can be used to complete the calibration.

Preferably, the measurement sides of each sensor in the system are deployed separately, so as to be independent (not connected) to each other. Each sensor constitutes an independent measurement unit, which independently completes the measurement (ADC and calibration) of its own component. This effectively avoids problems such as the eccentric error caused by the mutual stress between the sensors.

Preferably, generally speaking, a plurality of discretely arranged measuring units do not need any additional mechanism, and can naturally work together well. However, in some special scenarios, for reasons of beauty, equipment protection, or load-friendliness, a flexible or rigidly fixed connection layer can also be added between each measurement unit.

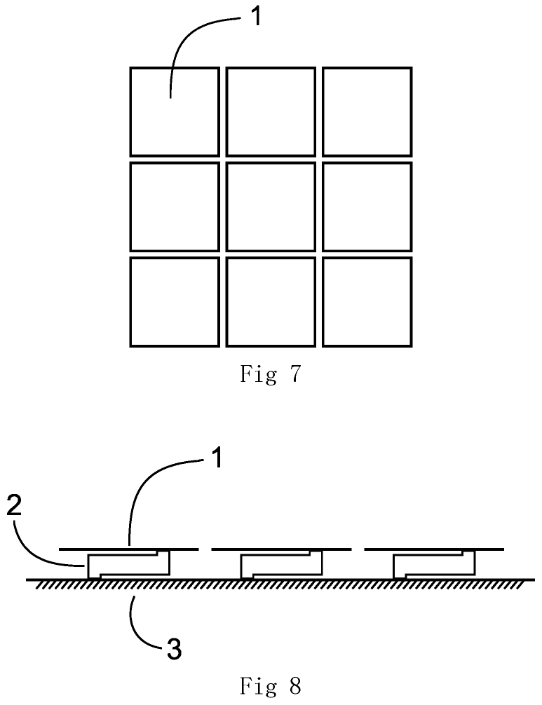

Please refer to FIG. 7 and FIG. 8, a pressure/weighing system, including the above-mentioned multi-sensor-based mechanical measurement system, also includes a support surface (support side) 3, a plurality of the sensors 2 are arranged on the support surface (support side) 3, and each of the sensors 2 is respectively provided with a measurement surface (measurement side) 1, where the measurement surface (measurement side) 1 is a tray (pallet) in this case.

Preferably, each of the trays is not connected, which ensures that the measurement surfaces (measurement sides) 1 of each sensor 2 are independent (not connected) of each other, and they each form an independent measurement unit, independently complete the measurement (ADC and calibration) work that belong to their own part of the component.

For pressure/weighing systems, each sensor 2 is usually fixed downwards (or upwards) on a support surface (support side) 3 individually (respectively), The supporting surface 3 can be any stable surface to which the sensor can be fixed, such as (including but not limited to) a cement/steel concrete surface (such as a cement floor, ceiling); a wood surface; a metal surface; a composite material surface; supports such as reinforced concrete beams/piers; steel beams, keels, etc. for buildings or shelves.

The sensor 2 can be fixed to the support surface 3 in various ways, such as (including but not limited to) bolts (screws), bayonet, welding, bonding and the like. The sensor 2 can be connected to the support surface 3 by various connecting pieces, such as (including but not limited to) gaskets, angle irons, profiles and the like.

On the top (or bottom) of the sensor, separate measuring surfaces (measuring sides) for carrying the actual load, such as independent trays (or hooks, hanging rods), are respectively fixed. The sensor 2 and the measurement surface (measurement side) 1 such as a tray can also be connected and fixed in any manner.

In this way, each sensor 2 in the system constitutes an independent single-sensor weighing unit. In order to ensure independence in its work, each weighing unit should be independent of each other. Specifically, for pressure/weighing units using pallets, the pallet (tray) of each sensor 2 should not come into contact with the pallets of other sensors 2 (other pressure units). Between the two pallets, according to the actual situation, it is usually better to have a distance of 1 to 50 mm.

However, since the measurement surfaces (measurement sides) 1 such as the trays are independent (not connected); therefore, even if all sensors 2 are fixed on the same support surface 3 and it is clear that the supporting surface 3 does not meet the requirements of absolute rigid body, absolute level and absolute flatness, etc., nor does it affect the individual measurement accuracy of each pressure/weighing cell. This is because they have nothing to do with each other, so various stresses such as levers (seesaws) and mutual torsion as described above will not be generated due to loads or other reasons. Therefore, the overall measurement accuracy is greatly improved.

However, obviously, the support surface (support side) 3 should not be too soft, so that the measurement surfaces 1 such as the pallet after adding the load contact each other due to the deformation of the supporting surface 3, resulting in interference due to mutual contact (connection). Therefore, the support surface 3 should still be as firm and stable as possible. But obviously, the present invention greatly reduces the requirements on the levelness, flatness and rigidity of the support surface 3.

Therefore, in addition to the above advantages, the present invention can greatly reduce the size and weight of the measurement system. Traditionally, in order to avoid the stress of various mutual interference between sensors as much as possible, it is necessary to ensure that components such as trays, brackets and chassis are as rigid as possible (deformed as little as possible), and kept it as flat and level as possible. Obviously, the higher the range and the larger the tray (pressure surface) area of the pressure/weighing system, the more difficult it will be to achieve the rigidity and flatness mentioned above (necessarily the use of thicker, stronger materials). Therefore, the existing pressure/weighing system usually increases geometrically in the parameters such as the weight and volume of its products with the increase of its range and tray area.

For example: a pressure/weighing system with a pallet area of 100×100 cm (1 square meter) and a measuring range of 1000 kg is usually much higher in volume and weight than the sum of nine measuring units with a pallet area of 32×32 cm and a measuring range of 200 kg. Even when the latter is combined, it has a measuring surface of at least 1 square meter and a total capacity of 1800 kg.

However, the present invention completely avoids the above-mentioned disadvantages by separating the measuring units and then recombining them. That is, every time the range and/or area in the measurement system is doubled, the volume and weight of the system will only increase by the same proportion (doubling) at most, without geometrically (exponentially) increasing its volume and/or weight.

This not only saves material significantly, reduces production costs and reduces product size. At the same time, it also greatly improves product scalability and adaptability: the linear expansion of elements such as measurement surface and range can be freely realized according to the actual needs of users.

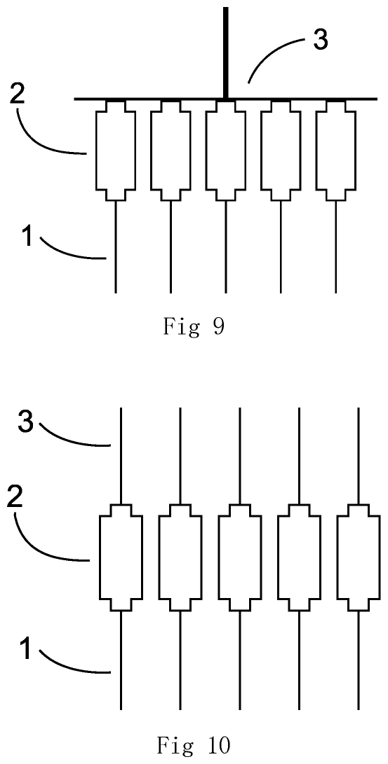

Please refer to FIG. 9. In a multi-sensor tensile force measurement system consisting of N sensors (of course there are at least N AI channels), each sensor can be connected to a measuring end (measuring side) 1 (each measuring side here is a steel cable) to form independent measuring side units. In this case, each sensor is an independent measuring unit. Each measuring unit can measure its own tensile force component independently of each other.

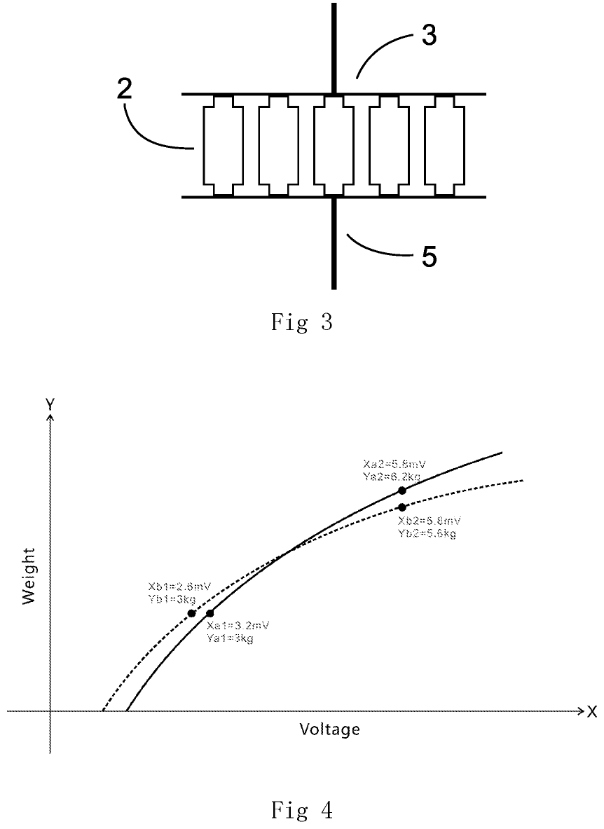

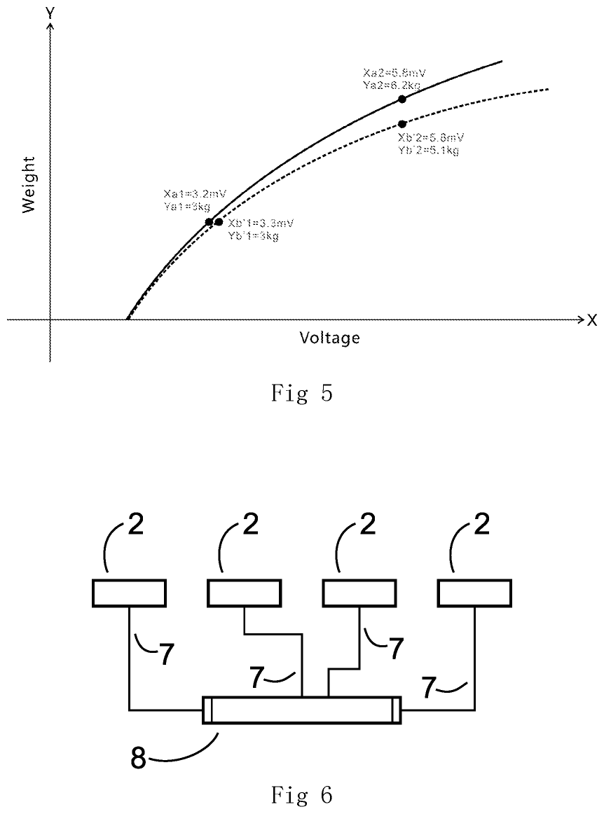

Referring to FIG. 10, due to the equivalence of the supporting end (support side) and the measuring end (measuring side) of the tensile force measurement system in the previously described case (please refer to FIG. 3 and its associated background note), We can also replace the supporting side with independent connecting devices such as steel cables. At this time, each sensor is still its own independent measurement unit. Each measuring unit can still measure its own tensile force component independently of each other. And at this time, the equivalence between the support end (support side) 3 and the measurement end (measurement side) 1 in the tensile force measurement system is restored.

Preferably, a plurality of the measurement sides (1) are connected through a connection layer (5).

Generally speaking, after each sensor 2 forms an independent measurement unit, they can naturally work well together without any additional mechanism. However, in some special scenarios, for reasons of aesthetics, equipment protection, or load-friendliness, a connection layer 5 may also be added between each measurement unit. As shown in FIG. 11, cover the connecting layer 5 on the tray of some or all of the measurement units. For example: in a set of multi-sensor discrete matrix weighing system with a total area of 100×100 cm consisting of 9 independent measuring units with a tray area of 32×32 cm combined in a 3×3 array, a connection layer can be deployed for aesthetics, small cargo friendly (seamless), protection of the weighing cell, etc. Preferably, the connecting layer 5 is a flexible element, for example, a 100×100 cm rubber pad (or any soft material such as silicone, textile, woven fabric, etc.) is laid on the surface of the tray 1. Although soft materials such as rubber and textiles deployed in a flexible manner such as simple laying can theoretically generate stress (mainly mutual torsion) between different weighing cells, the stress is usually negligible because it is too weak.

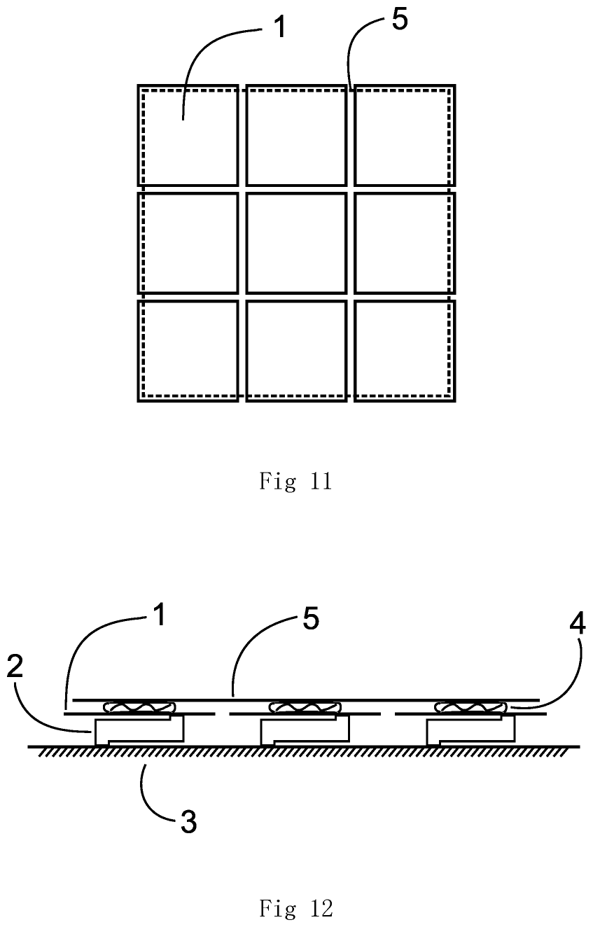

Similarly, in addition to the above-mentioned soft materials, the connecting layer 5 can also be various types of hard large cover plates, such as (including but not limited to) metal plates, PP plates, glass steel plates, plexiglass plates, plywood, MDF, wooden boards, PC board, PVC board, etc., so as to achieve the purpose of protection and beauty similar to the previous one. Preferably, a buffer layer 4 is provided between the connection layer 5 and the tray 1, as shown in FIG. 12, The more recommended deployment method is: firstly lay rubber rings, rubber pads, PVC pads, springs, hydraulic mechanisms or buffer layers of other soft materials on the measurement side (tray, etc.) of each independent measurement unit. Then, on the buffer layer 4, a whole hard cover plate such as a metal plate and a glass fiber reinforced plastic plate is laid. The advantage of this is that since the tray is usually made of hard materials such as metal, the buffer layer 4 in the middle can play a role of buffering and protection between the measurement side 1 such as the tray and the connecting layer 5.

In addition, this sandwich deployment has two additional benefits:

1. A large rigid cover plate (100×100 cm in the example above) can transfer the load relatively more evenly to the individual measuring cells in the system.

2. Ring-shaped soft materials such as rubber rings have better mechanical distribution for the force applied to the sensor by the load. After the annular rubber gasket is placed on the square measuring cell tray, it is assumed that the tray is square and the sensor is fixed in the center of the tray. Then when the measuring unit is under load, its longest force arm distance is shortened from half of the square diagonal to the radius of the rubber ring. We know that for a single sensor system, a smaller force arm means a lower eccentric error (this is equivalent to the fact that the load can never be applied to the four corners of the pallet since all four corners have been lifted by the circular rubber pads). This improves the overall accuracy of the system, and also facilitates the creation of independent weighing units with a larger coverage area. Obviously, in addition to squares, the above principles can also be easily extended to any rectangle, parallelogram, ellipse, triangle, trapezoid, pentagon, hexagon and other polygons or other geometric shapes.

In summary, after adding a sandwich-type flexible connection layer to the whole measurement system, although it is possible to introduce slight mutual stress between the sensors, it can get the advantages of beautiful, seamless (friendly to small goods), durable, easy to maintain, etc. Even due to the reduction of the eccentric error of each weighing cell (shortening of the maximum force arm), the overall measurement accuracy may not decrease but increase.

Of course, in some special applications, part or all of the weighing cells can also be rigidly fixed. For example, fasten a 100×100 cm steel plate to the 9 measuring units in the above example by means of welding, screws and other fixing means. Obviously, if good rigidity, levelness and flatness cannot be guaranteed, then this fixing method will generate strong stress between the sensors (both lever stress and mutual torsion stress), and these stresses are likely to become more pronounced as the system load is (unbalanced) heavier. But even in this situation, the present invention still has obvious advantages over the prior art:

1. It avoids all the disadvantages caused by the junction box (hub), such as poor accuracy, difficult pairing, complex tuning, extra noise, extra faults, and limited number of sensors.

2. Even with the stress and eccentric error of a rigidly fixed cover, it is easier and more convenient to perform the calibration via a purely digital software system rather than via a potentiometer in the junction box.

Further, even if a rigid connection is used, a sandwich structure similar to the previous one can still be adopted, that is, a soft buffer layer 4 made of rubber or other materials is added between each measuring unit tray and the integral cover plate. The buffer layer 4 still has the advantages of absorbing impact force and reducing the eccentric error of each measuring unit. At the same time, the buffer layer can also absorb part of the stress, making the measurement results more accurate.

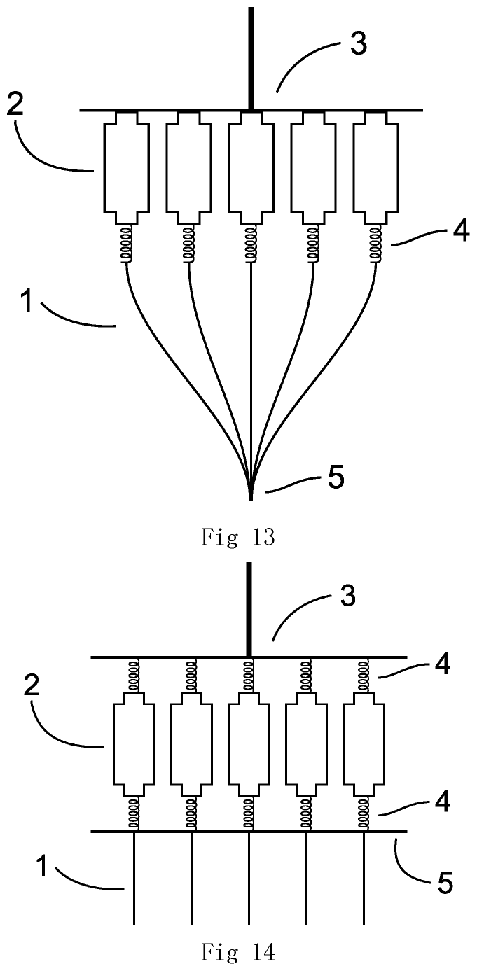

Referring to FIG. 13, in the tensile force measurement system, soft or hard flexible or rigid connection layers 5 can also be added to multiple independent measurement units. For example: FIG. 13 shows a way of adding springs, hydraulic mechanisms, etc. to each independent measuring end (measuring side) as a buffer layer 4, and twist it into a loose large steel cable (flexible connection) as the realization of the connection layer 5.

Please refer to FIG. 14. Both ends of each measuring unit in the tensile force measuring system are respectively fixed on a steel plate by elastic (hydraulic or spring, etc.) suspension, connecting the hard (steel plate) connection layer 5 with the flexible (spring) buffer layer 4.

Or fix both ends of each measuring unit on the same reinforced concrete column (There are two columns in total, each column has N rigid fixed points to connect the steel cables at the same end of N units: rigid (fixed point) butt rigid (reinforced concrete column) connection layer); Or fix both ends of each measuring unit directly on a rubber plate (A total of two rubber sheets, each with N fixed points connecting the steel cables at the same end of the N units: rigid (fixed point) butt soft (rubber sheet) connection layer) And various means to implement various permutations and combinations of soft/hard materials and flexible/rigid connections.

Of course, when it is necessary to add a connection layer 5, if there is no clear reason, we still recommend the use of a better performing flexible connection. However, as mentioned above, even with the rigidly connected integral cover, the present invention still has significant advantages over the prior art.

When the flexible or rigid connection layer 5 on all measurement units is completed, the overall secondary calibration of the system can be performed (if the connection layer is not required, this step can also be skipped and the secondary calibration is performed directly). At this point, after successfully deploying non-goods loads such as rubber pads, springs, steel plates, containers (baskets, etc.), and after the above-mentioned processing steps of scaling, offset, weighted accumulation, and formula transformation, the obtained secondary calibration value is the 0-point weight value of the current system. In other words, the overall superposition value including rubber pads, springs, steel plates, containers, etc. is the overall 0-point value of the current measurement system.

After determining the 0-point value, we can also determine the overall calibration curve of the system by adding weights continuously. If a rigid connection layer is used, automatic or manual fine-tuning of parameters such as scaling factors, offsets, and weights of each measurement unit may be required to eliminate eccentric errors. Conversely, when a flexible connection layer is used, or no connection layer is used, high accuracy and small errors can often be achieved directly without similar fine-tuning. Of course, in the case of very bad external conditions such as the lack of a sufficiently stable support surface, the support surface is too rugged, the inclination of the measurement surface is large, etc. It may occasionally be necessary to fine-tune some of the measurement units using the method described above, even if no rigid link layer is used.

It can be seen that the secondary calibration is mainly used for calibration at the overall level of the system, eliminating the additional (non-cargo) load (taring) caused by the connection layer and container, and correct the eccentric error caused by other external factors such as rigid connection layer. The secondary calibration process plays an important role in the final overall accurate measurement of the system.

A measurement method based on a multi-sensor mechanical measurement system, comprising the following steps:

Step 1: The signals of the plurality of sensors 2 are respectively transmitted to the digital-to-analog conversion unit 8 through the respective analog input channels 7;

Step 2: Perform primary calibration on each of the sensors 2 respectively;

Step 3: Perform secondary calibration according to the primary calibration results of all the sensors 2.

Different from the primary calibration process, the secondary calibration is a process of inputting the output measurement values of each sensor after the primary calibration, re-calibrating these input values, and finally outputting the overall measurement result value of the system.

In other words, the input of the secondary calibration is the output of each sensor after the primary calibration process, and the output of the secondary calibration can be used as the measurement result of the whole system for subsequent use and processing.

The secondary calibration process usually includes the following steps:

Step 1: Perform scaling and offset processing on the output measurement value of each sensor through primary calibration, and use the processing result as the current output value of the measurement unit to participate in the next calculation. For example: the measurement value of each measurement unit can be converted such as “output value=scaling factor×measurement value+offset”, where “Scale Factor” and “Offset” are configurable items, which are automatically configured by the system or manually configured by the administrator. Of course, the above formula is just an example, and in actual use, the measured value obtained from one calibration can be converted into an output value through any complexity. The conversion method can be either a formula such as the aforementioned “scale factor×measurement value+offset”, or a script or program of arbitrary complexity.

Step 2: Accumulate the output values of all measurement units in this round. The “accumulate” here is not limited to simple arithmetic addition, but can also be various forms of superposition operations such as (including but not limited to) weighted accumulation, weighted square sum, weighted mean square sum, and weighted accumulated mean square error. For example, a weighted summation algorithm with N measurement units can be defined as follows: superposition value=weight 1×measurement unit 1 output value+weight 2×measurement unit 2 output value+ . . . +weight N×measurement unit N output value.

Step 3: Perform further processing such as taring, calibration, and arbitrary complexity transformation on the accumulated value generated in the second step, and use the processing result as the final result of the overall secondary calibration of the system. The transformation here can be either a formula such as “scale factor×measurement+offset−tare” above, or a script or program of arbitrary complexity.

It is easy to see that in the present invention, no matter whether each sensor is connected using discrete fixing, flexible connection surface or rigid connection surface, its functions and precautions of the secondary calibration process are similar, and its main functions are:

1. The output values of the individual measuring units are accumulated (superimposed) in some form in a reasonable manner.

2. Eliminates and calibrates measurement deviations caused by factors such as: additional stress, errors, imbalances, counterweights introduced by various processes such as “making independent arrangements” and “implementing connection layer”, and abnormal loads (connection layer, containers, etc.).

In summary, the present invention adopts the design of no junction box (hub) in which each sensor is independently connected to the ADC, combined with discrete calibration, discrete arrangement, secondary calibration, and optional connection layer design, to achieve a mechanical measurement system with the advantages of high accuracy, high stability, high reliability, low error, low cost, easy maintenance, low failure rate, no need for pairing, strong adaptability to environment and location, light and compact, and flexible expansion.

It should be noted that although the embodiments of the present invention are only directed to pressure/weighing and tension measurement systems, but its principles and ideas are obviously also applicable to various other mechanical measurement systems such as shear force, rotational force, horizontal force, friction force, support force, and load force. Any use of the method described in the present invention in various mechanical measurement systems including but not limited to the above all belong to the protection scope of the present invention.

1. A multi-sensor based mechanical measurement system, characterized in that: Including a sensor (2), a digital-to-analog conversion unit (8) and a calculation unit; The said sensor (2) includes a plurality of sensors, and each of the said sensors (2) is connected to the said digital-to-analog conversion unit (8) through a respective analog input channel (7); The said digital-to-analog conversion unit (8) converts the data and transmits it to the said calculation unit; The said calculation unit performs a separate primary calibration on the sensor (2) corresponding to each of the said analog input channels (7) according to the signal transmitted by each of the said analog input channels (7), and perform secondary calibration according to the primary calibration results of all the said sensors (2).

2. The multi-sensor-based mechanical measurement system according to claim 1, wherein: Also includes the support side (3), one ends of a plurality of the said sensors (2) are all connected to the said support side (3), the other ends of the plurality of said sensors (2) are respectively connected to the plurality of measurement sides (1), and there is no connection between each of the said measurement sides (1).

3. The multi-sensor-based mechanical measurement system system according to claim 2, wherein:
A plurality of the said measurement sides (1) are connected through a connection layer (5).

4. The mechanical measurement system based on multiple sensors according to claim 3, is characterized in that: a buffer layer (4) is arranged between the said connection layer (5) and the said measurement side (1).

5. A measurement method based on a multi-sensor mechanical measurement system, characterized in that: Include the following steps:
Step 1: The signals of the multiple sensors (2) are respectively transmitted to the digital-to-analog conversion unit (8) through the respective analog input channels (7);
Step 2: Perform a calibration on each of the said sensors (2) respectively;
Step 3: Perform secondary calibration according to the primary calibration results of all the said sensors (2).

6. A measurement method according to claim 5, is characterized in that: The secondary calibration in the step 3 includes the following steps:
Step 3.1: Perform conversion processing of arbitrary complexity on the output measurement value of each sensor (2) after the primary calibration, and use the processing result as the output value;
Step 3.2: Accumulate the output value in the step 3.1, and output the superimposed value;
Step 3.3: Perform further processing of taring, calibration, and arbitrary complexity transformation on the superimposed value in Step 3.2, and use the processing result as the final result of the secondary calibration.
